(19) United States
(12) Patent Application Publication
(10) Pub. No.: US 2006/0231779 A1
(43) Pub. Date: Oct. 19, 2006

(54) Exterior inspection apparatus and exterior inspection method

(75) Inventor: Shinobu Isobe, Tateyama-shi (JP)

Correspondence Address: COHEN, PONTANI, LIEBERMAN & PAVANE, 551 FIFTH AVENUE, SUITE 1210, NEW YORK, NY, 10176, US

(73) Assignee: UMC Japan, Tateyama-shi (JP)

(21) Appl. No.: 11/398,878

(22) Filed: Apr. 6, 2006

(30) Foreign Application Priority Data
Apr. 18, 2005 (JP) P2005-120179

(51) Int. Cl. G01N 21/86

(52) U.S. Cl. 250/559.42

(57) ABSTRACT

Filters that have transmission wavelength characteristics that change in stages are provided. An object being inspected is specified based on spectrum characteristics that are created from image data of images that have passed through the filters and been picked up by a CCD camera. The image data as well as the spectrum characteristic data are recorded as a database on a hard disk. Then, a comparison is made between this database and the data of the object being inspected.

### BACKGROUND OF THE INVENTION

1. Field of the Invention

The present invention relates to an exterior inspection apparatus and an exterior inspection method for inspecting the exterior of an industrial product.

Priority is claimed on Japanese Patent Application No. 2005-120179, filed Apr. 18, 2005, the contents of which are incorporated herein by reference.

2. Description of the Related Art

Conventionally, in the various steps to manufacture a semiconductor manufacturing apparatus, there are cases when residue such as resin or metal foreign matter from minute wiring portions adheres to a product. There is a possibility that this foreign matter will cause the quality of, for example, a semiconductor product to deteriorate markedly. Because of this, an exterior inspection apparatus is provided that makes an inspection of the exterior using image processing, and control is performed in order to prevent defective products being shipped.

As is shown in FIGS. 8 and 9, a conventional exterior inspection apparatus 100 is formed by a monochrome CCD camera 103 that has a lens 102, an image processing device (not shown), and a microscope (not shown) that is located at a position between the CCD camera 103 and an object being inspected 101.

An exterior inspection performed by this conventional exterior inspection apparatus 100 will now be described.

Firstly, an image of a surface of the object being inspected 101 is picked up using the CCD camera 103, and image information is fetched from the CCD camera 103 into the image processing device. Next, a comparison is made between image data 105 that has been registered in advance as data for an acceptable product and image data 105a of the object being inspected that is created based on the image information received from the CCD camera 103. If the two do not match, then it is determined that an abnormality exists in the object being inspected 101, and an abnormality image (i.e., shape and size) on the object being inspected 101 as well as information such as the position and the like are recorded. Specifically, the inspection concentrates on detecting the existence or otherwise, deformation, and shift in position and the like of foreign matter 101a, as well as portions that can be recognized as the shape and the like thereof. Moreover, as is shown in FIGS. 9A, 9B, and 9C, pixel data 107a in pixel units having 256 gradations of black and white (i.e., contrast resolution) is created from the image data 105a, and a comparison is made by a comparison determining section 108 between this pixel data 107a and pixel data 107 having 256 gradations of black and white (i.e., contrast resolution) that is registered in advance in a hard disk 106 as acceptable product data. The comparison determining section 108 has a size analysis section 108a and a shape analysis section 108b and is able to classify items into approximate shape and color density groups.

The exterior inspection apparatus described in Japanese Patent Application (Laid-Open) No. 2002-82048 is an apparatus that performs image processing such as that described above.

However, this conventional exterior inspection apparatus 100 has a low sensitivity to color, and it is difficult to detect substances having light coloring or color transmissivity, and to detect slight discoloration and the like.

Therefore, a method has also been proposed in which an exterior inspection is performed using filters that enhance contrast by transmitting the required color wavelength. However, it is still necessary to limit an object that is being measured using filter attenuation characteristics, so that this method is poorly suited for general use.

Moreover, as is shown in FIG. 10 and FIG. 11, an exterior inspection apparatus 150 has also been proposed that, using a color CCD 153 that is made up of three CCD units, creates image data 154 by picking up an optical image of the object being inspected 101 via filters 157 for color cameras. However, the quantity in this case of the image processing data is 100,000 times greater than in the exterior inspection apparatus 100 that uses the monochrome CCD camera 103, and not only is an extended time required for image processing, but this method does not directly measure a single wavelength (i.e., this method employs a synthesis of three wavelengths obtained from the three CCD units). As a result, the problem arises that the accuracy is poor.

Because of this, there is a need to acquire image data of a single wavelength more accurately, and to as far as possible eliminate the effects of the base color, reflected light, approximate light and the like surrounding an object being inspected, and to thereby improve the inspection accuracy. In the conventional exterior inspection apparatus 100, because an inspection is performed that changes the intensity of reflected light from the object being inspected 101 into the 256 gradations of pixel data 107a, if the color density of the object being inspected 101 is low, then an image picked up by the monochrome CCD camera 103 tends to have a low intensity difference between the two lights.

In order to improve the detection accuracy, it is desirable that the contrast ratio is increased between the object being inspected and the area surrounding the object being inspected.

In order to increase the contrast ratio between the object being inspected and the area surrounding the object being inspected, a method has been proposed in which the peak wavelength of each color is measured using a spectrum analyzer or the like, and the inspection is then performed using a wavelength in which the contrast ratio is high.

However, in this method, the measurement ends up being only a measurement of a spectrum in which the measurement point and irradiation of specific wavelength light are limited, resulting in the inspection being limited to a narrow range and being limited to an inspection of a specific substance. Accordingly, this method cannot be used for inspections to locate a number of substances from among a wide range of objects being inspected, and inspections to confirm that a particular substance is not present.

### SUMMARY OF THE INVENTION

The present invention was conceived in view of the above described circumstances. An object of the invention is to provide an exterior inspection apparatus and an exterior inspection method that make it possible to determine not only the shape of a substance, but also to determine each one of a variety of substances that are characterized by the unique color of each substance, and that also make it possible to detect with a high degree of accuracy discoloration and residue of abnormalities and the like using a simple structure.

In order to achieve the above object, according to a first aspect of the invention, an exterior inspection apparatus that picks up an image of an object being inspected and inps an exterior of this object is provided, including: a plurality of filters that are provided in stages for differing transmission wavelengths and are positioned so as to face the object being inspected, and that only transmit a specific wavelength from an optical image of the object being inspected; an image pickup device that picks up an optical image transmitted through the filter and outputs image data for each wavelength region; an image processing device that creates spectrum characteristic data by analyzing differences between contrast ratios by using a comparison of the image data output for each wavelength region, and then specifies a substance based on the spectrum characteristic data; and a database device on which the image data and the spectrum characteristic data are readably recorded as case information, wherein the image processing device comprises: a substance specifying section that, by reading the case information recorded on the database device and comparing this case information with the image data and spectrum characteristic data of the object being inspected, is able to specify the class of the object being inspected and then output classification information and distribution information; and a search processing section that searches for and extracts the image data and the spectrum characteristic data that are recorded as case information on the database device.

Preferably, it further comprises a calculating device that calculates from the image data a wavelength spectrum distribution of reflection light reflected from the periphery of the object being inspected that forms a background noise component of the object being inspected, and then attenuates wavelength region data of this wavelength spectrum distribution.

Further, preferably, the filter is a planar filter having a high transmittance, and the filter is a variable optical filter that is provided with a variable device that changes the transmission wavelength region of the filter.

According to a second aspect of the invention, an exterior inspection method is provided, including: providing an exterior inspection apparatus according to the first aspect; picking up an image of an object being inspected; and inspecting the object being inspected.

In the present invention, a wide ranging exterior inspection can be made of the entire object being inspected and it is possible to detect discoloration and residue such as resin and foreign matter on the object being inspected. It is thus possible, based on color wavelength characteristics of the resin and foreign matter, to instantly specify the substance that is present.

Accordingly, it is possible to achieve a highly accurate exterior inspection apparatus that has a simple structure yet is able to provide confirmation of failures in an object being inspected without exception.

These and other objects, characteristics and advantages of the present invention will be apparent to those skilled in the art from the description of the preferred embodiments of the invention as depicted in the attached drawings and from the attached claims.

### BRIEF DESCRIPTION OF THE DRAWINGS

The above features and advantages of the invention will become more apparent by describing in detail exemplary embodiments thereof with reference to the attached drawings in which:

FIG. 1 is a schematic view showing an example of an exterior inspection apparatus according to the present invention.

FIG. 2 is a schematic view showing an example of an exterior inspection apparatus according to the present invention.

FIG. 3 is a schematic view showing an example of an exterior inspection apparatus according to the present invention.

FIGS. 4A and 4B are views showing an example of an exterior inspection apparatus according to the present invention with 4A showing light transmission wavelength signals and 4B showing pixel data.

FIG. 5 is a block diagram showing an example of an exterior inspection apparatus according to the present invention.

FIG. 6 is a schematic view showing an example of an exterior inspection apparatus according to the present invention.

FIGS. 7A and 7B are schematic views showing an example of an exterior inspection apparatus according to the present invention.

FIGS. 8A and 8B are schematic views showing an example of a conventional exterior inspection apparatus.

FIGS. 9A, 9B, and 9C are views showing an example of a conventional exterior inspection apparatus with 9A and 9B being schematic views and 9C being a block diagram.

FIG. 10 is a schematic view showing an example of a conventional exterior inspection apparatus.

FIG. 11 is a schematic view showing an example of a conventional exterior inspection apparatus.

FIGS. 12A, 12B, and 12C are views illustrating an embodiment of the exterior inspection apparatus according to the present invention and shows a measurement area of a sample surface.

FIGS. 13A and 13B are views illustrating an embodiment of the exterior inspection apparatus according to the present invention and are graphs showing the luminance at each wavelength.

FIGS. 14A, 14B, and 14C are views illustrating an embodiment of the exterior inspection apparatus according to the present invention and are graphs showing the luminance at each wavelength.

FIGS. 15A and 15B are views illustrating an embodiment of the exterior inspection apparatus according to the present invention and are graphs showing the luminance at each wavelength.

### DETAILED DESCRIPTION OF THE INVENTION

A first embodiment of the exterior inspection apparatus of the present invention will now be described with reference made to the drawings.

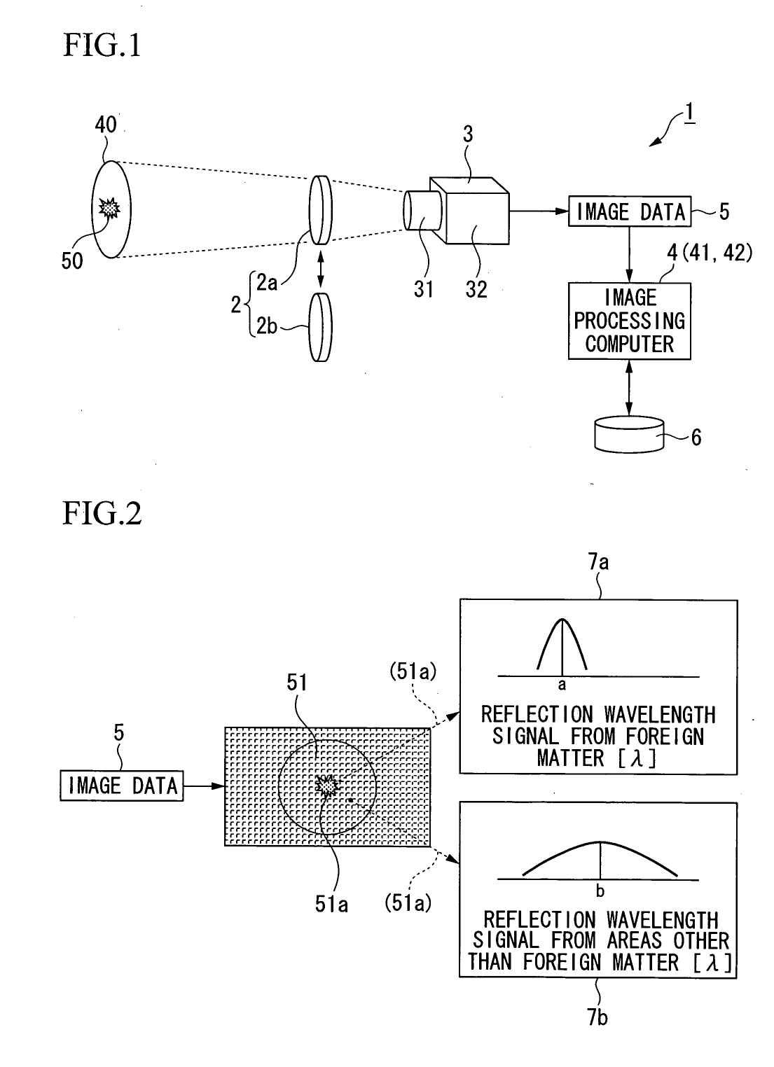

FIGS. 1, 2, and 3 are views illustrating an exterior inspection apparatus 1 of the present embodiment. This exterior inspection apparatus 1 is schematically formed by filters 2 (2a and 2b), a plurality of which are provided in stages in different transmission wavelengths, a CCD camera 3 (i.e., an image pickup device) that picks up an optical image of an object being inspected 40 that has passed through the filter 2 and outputs image data 5 for each wavelength region, an image processing computer 4 (i.e., an image processing device) that creates spectrum characteristic data by analyzing differences between contrast ratios from a comparison of the image data and then specifies the substance based on this spectrum characteristic data, and a hard disk 6 (i.e., a database device) on which the image data and the spectrum characteristic data are readably recorded as case information.

In addition, a microscope (not shown) that is used to enlarge optical images is placed at an optional position between the object being inspected 40 and the CCD camera 3, and a light source that is used to make the optical images clearer is placed in the vicinity of the object being examined 40.

As is shown in FIG. 1, the filters 2a and 2b are planar optical filters that are provided between the object being examined 40 and the CCD camera 3, and have the characteristic of only transmitting light of a fixed wavelength region that has a unique color.

The filters 2a and 2b each transmit light of a different wavelength region, and the filter to be used can be changed using a switching device (not shown) at the time when an image is picked up by the CCD camera 3 (described below).

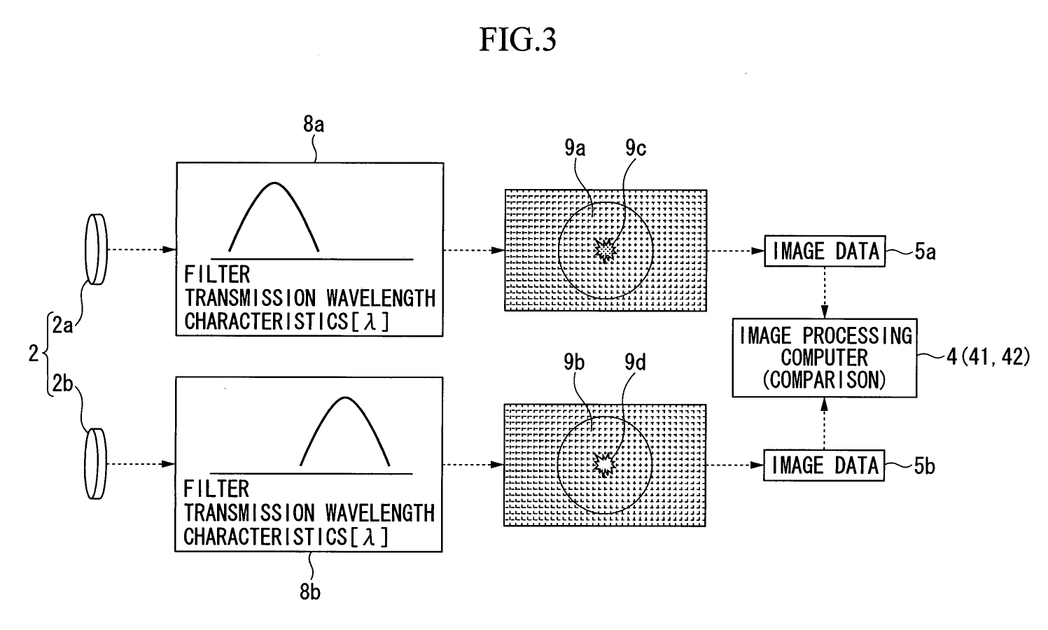

As is shown in FIG. 3, each of the filters 2a and 2b of the present embodiment have specifications that allow them to transmit light having the transmission wavelength characteristics 8a and 8b.

In the present embodiment, a bandpass filter centered on a wavelength of 600 nm is used for the filter 2a, and this filter 2a transmits an optical image having the transmission wavelength characteristics 8a. A bandpass filter centered on a wavelength of 500 nm is used for the filter 2b, and this filter 2b transmits an optical image having the transmission wavelength characteristics 8b.

The range of the wavelength region of the filter 2 is preferably a range that includes the absorption light or reflection light wavelength range of the substance constituting the object being inspected 40. However, provided that a wavelength that enables an image to be picked up when the contrast ratio is high is included, then it is not necessary to use filters for a number of wavelength regions and it is possible for only a filter for the appropriate wavelength to be used.

If the spectrum characteristics of the object being inspected 40 are known in advance, then it is sufficient to use a filter that matches the aforementioned wavelength center and a filter for wavelengths peripheral thereto.

If, however, the spectrum characteristics of the object being inspected 40 are not known in advance, then filters are prepared in which the transmission wavelength is changed in intervals of, for example, 50 nm, and an image is acquired while these filters are changed in sequence. Analysis can then be performed using the data from the highest contrast image.

For the filter 2 it is possible to use an optical filter made of resin or glass that has been dyed using a dying process, or a prism filter that transmits only a specific wavelength by using the refractive index of the light. In addition, it is also possible to use filters formed from liquid crystals, organic material, or having a diffraction grating structure or the like, and the filter may be selected and employed as is appropriate.

The CCD camera 3 picks up an optical image of the object being inspected 40 that has passed through the filter 2, converts it into image data 5 (i.e., 5a and 5b) and outputs it

An optical image of the object being inspected 40 that is condensed by an image pickup lens 31 is converted into electrical signals by a CCD element (not shown) that is provided inside a camera body 32, and is output to the outside of the CCD camera 3 as the image data 5.

The image data 5 that is output from the CCD camera 3 is output as data for each of the wavelength regions that are transmitted through the above described filters 2a and 2b.

The image data 5 that is output from the CCD camera 3 has a higher resolution in proportion to the number of cells (i.e., pixels) in the CCD camera. Namely, a highly accurate inspection can be made by using a CCD camera 3 that has a large number of cells.

The CCD camera 3 is also able to fetch the brightness of the optical image of each cell in voltage signals expressed in 256 gradations. For example, the brightness may be expressed by being converted into numerals with bright light given the value 256 and dark light given the value 0.

As is shown in FIG. 3, the image data 5 output from the CCD camera 3 is output by the CCD camera 3 as pixel data 9a and 9b.

In the present embodiment, a description is given using a CCD camera as an image pickup device, however, an image pickup device that uses another image pickup method may be used. For example, an image pickup device that uses a solid state element or an electron tube or the like may be selected and employed in appropriate cases.

The image processing computer 4 fetches the image data 5a and 5b that has been output for each wavelength region from the CCD camera 3. The image processing computer 4 then compares the image data 5a and 5b for each wavelength region and creates spectrum characteristic data by analyzing the differences in the respective contrast ratios. The image processing computer 4 then specifies the substance based on this spectrum characteristic data. The image processing computer 4 has a substance specifying section 41 that reads image data and spectrum characteristic data that are recorded as case information on the hard disk 6 (described below) and makes a comparison with the image data 5 of the object being inspected 40. As a result, the substance specifying section 41 is able to specify the class of foreign matter 50 or the like that is adhering to the object being inspected 40, and then output classification information and distribution information.

The image processing computer 4 also has a search processing section 42 that searches for and extracts spectrum characteristic data and image data that are recorded as case information on the hard disk 6 (described below).

The hard disk 6 (i.e., a database device) is a recording device that records the image data and spectrum characteristic data as readable case information (i.e., a database).

The exterior inspection apparatus 1 of the present embodiment performs the following action using the above described structure.

As is shown in FIG. 1, an optical image of the object being inspected 40 is picked up by the CCD camera 3 via filters 2a and 2b that can be switched and via a microscope (not shown), and the CCD camera 3 outputs image data A light source (not shown) that is used to make the optical image of the object being inspected 40 more distinct is placed in the vicinity of the object being inspected 40.

The image processing computer 41 fetches and analyzes the image data 5 and is able to specify the shape, size, material and the like of the foreign matter 50 present on the object being inspected 40.

Moreover, it is also possible to quickly specify the material of the foreign matter 50 by placing the image data 5 on a data base and then recording and saving it on the hard disk 6, and by afterwards reading the image data 5 from the hard disk 6 during an inspection using the exterior inspection apparatus 1.

A description will now be given using FIGS. 1, 2, and 3 of an exterior injection method that employs the exterior inspection apparatus 1 of the present embodiment using a semiconductor substrate as the object being inspected 40.

White light or light that includes the transmission wavelength of the filter is irradiated by a light source (not shown) onto a semiconductor substrate (i.e., the object being inspected 40) that has been obtained by coating photosensitive resist onto a semiconductor substrate and then forming a resist pattern by performing exposure and developing processing. Transmission light of the optical image of the semiconductor substrate (i.e., the object being inspected 40) at this time is picked up by the CCD camera 3 using the filter 2a that selectively transmits a specific wavelength region which, in the present embodiment, is a wavelength region centered on 600 nm.

If foreign matter 50 such as resin is present on the semiconductor substrate (i.e., on the object being inspected 40), this foreign matter 50 has different reflection spectrum characteristics from those of the semiconductor substrate surrounding it. As is shown in FIG. 2, a spectrum peak of a foreign matter image 51a that appears in a center portion of the pixel data 51 show a wavelength peak a like the spectrum characteristics 7a, while a wavelength peak b like the spectrum characteristics 7b is shown by the periphery of the foreign matter 50. By making selective transmissions using the filters 2a and 2b whose transmission wavelengths are the regions around the respective wavelength peaks, a contrast image 9a of the specific wavelength region of the resin and a contrast image 9b of the periphery of the foreign matter 50 are obtained.

In the contrast image 9a, it is possible to detect a foreign matter image 9c of the center portion of the object being inspected 40 when the contrast is sharp, however, in order to obtain only the information of this foreign matter image 9c, the information is narrowed down by making a comparison with the contrast image 9b. At this time, by comparing the contrast image 9a and the contrast image 9b in pixel units, an image can be obtained in which the portions that are different are emphasized. Namely, image processing is performed using the image processing computer 4 based on the respective groups of image data 5a and 5b, and image data 4, 41, and 42 in which the contrast difference between the contrast image 9a and the contrast image 9b (i.e., the contrast difference between the foreign matter images 9c and 9d) is greatest can be obtained.

Note that, by recording the image data 5a and 5b and the data of the spectrum characteristics 7a and 7b on the hard disk 6, in subsequent inspections it is possible to rapidly extract a central spectrum wavelength that shows materials in addition to the material, shape, size, position and the like of the foreign matter 50. As a result, these inspection items can be inspected simultaneously.

An inspection of the shape, size, and position of the actual object being inspected 40 may be performed by comparing an image of the object being inspected 40 to an image of a reference product that is considered to be a good quality product. If there is no difference, then the object being inspected 40 maybe determined to be a good quality product, while if there is a difference, then the object being inspected 40 may be considered to be defective.

As has been described above, in the exterior inspection apparatus 1 of the present embodiment a structure is employed in which filters 2a and 2b that have transmission wavelength characteristics that vary in stages are provided, and the foreign matter 50 on the object being inspected 40 is specified based on the spectrum characteristics 7a and 7b that are created from the image data 5a and 5b of images that have passed through the filters 2a and 2b and have been picked up by the CCD camera 3. In addition, the image data 5a and 5b as well as the spectrum characteristics 7a and 7b are recorded as a database on the hard disk 6, and a comparison is made between the database and the data of the object being inspected 40.

As a result, a wide ranging exterior inspection is made of the entire object being inspected 40 and it is possible to detect residue of foreign matter 50 such as resin on the object being inspected 40, as well as abnormalities such as discoloration on the object being inspected 40. It is thus possible, based on color wavelength characteristics of the foreign matter such as resin, to instantly specify the substance that is present.

Accordingly, it is possible to achieve a highly accurate exterior inspection apparatus that has a simple structure yet is able to provide confirmation of failures in the object being inspected 40 without exception.

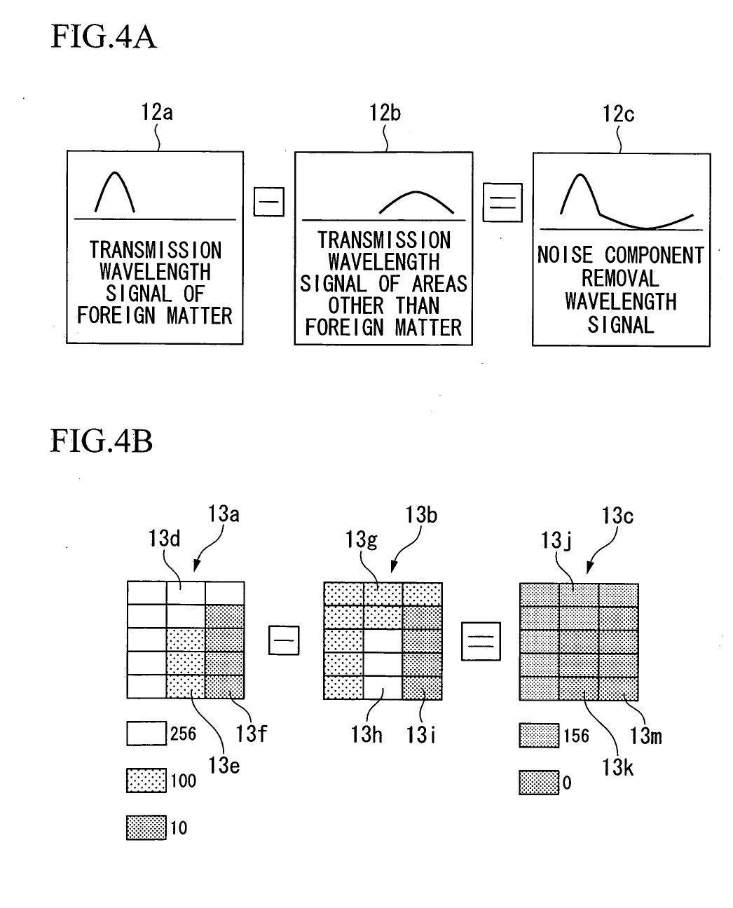

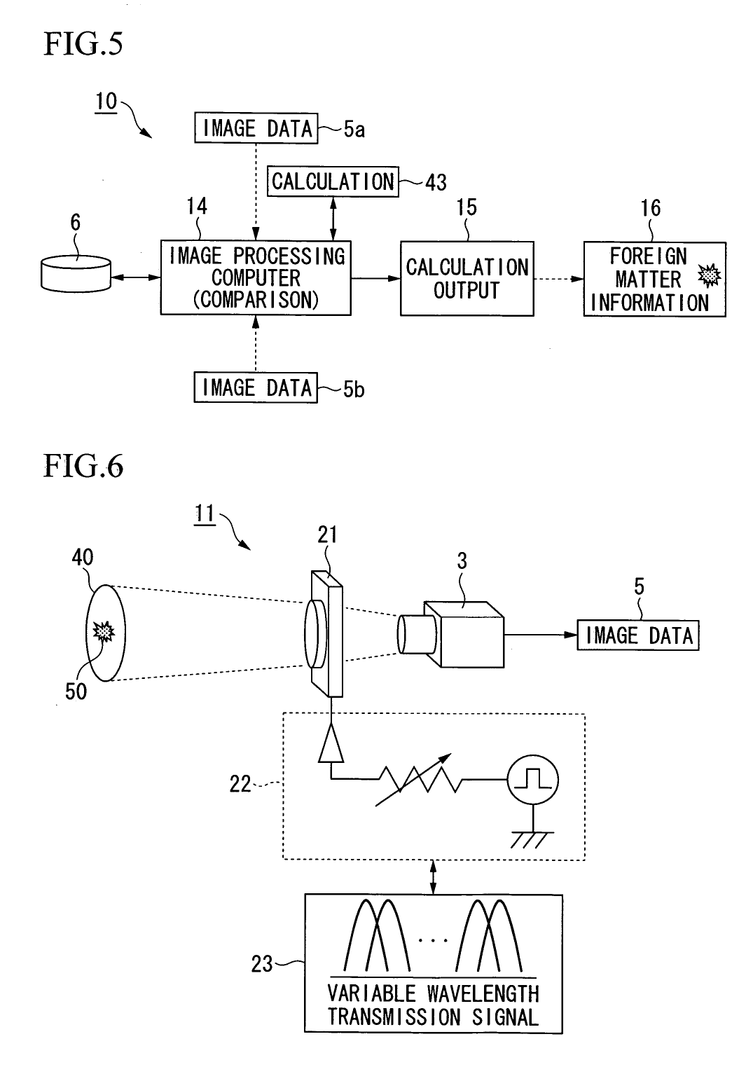

The second embodiment of the exterior inspection apparatus of the present invention will now be described using FIGS. 4A and 4B and FIG. 5.

In the description given below, components that are identical to those of the exterior inspection apparatus 1 of the first embodiment are given the same descriptive symbols and a description thereof is omitted.

The exterior inspection apparatus 10 of the present embodiment differs from the exterior inspection apparatus 1 of the first embodiment in that an image processing computer 14 is provided with a calculating device 43 that calculates, from among the image data, the wavelength spectrum distribution of reflection light from the periphery of the object being inspected 40 which forms a background noise component of the object being inspected 40, and then attenuates the wavelength region data of this wavelength spectrum distribution.

A description will now be given using the example shown in FIGS. 4A and 4B of the action of the exterior inspection apparatus 10 in which the calculation device 43 is provided in the image processing computer 14.

A transmission wavelength signal 12b that is obtained from the image data 5b of the optical image that has passed through the filter 2b (see FIG. 1) is subtracted from a transmission wavelength signal 12a that is obtained based on the image data 5a of the optical image that has passed through the filter 2a (see FIG. 1). As a result, the transmission wavelength signal 12a is emphasized, and it is possible to obtain a noise component deleted signal 12c in which unnecessary data has been attenuated.

As is shown in FIG. 4B, in the exterior inspection apparatus 10 of the present embodiment in processing to emphasize a peak wavelength characteristic appearing in the transmission wavelength signal and attenuate or remove everything apart from this peak wavelength, contrast signals (i.e., brightness values) of the image data 5a and 5b are changed into 256 gradations of pixel units using the numerical values 0 to 255.

The pixel data 13a, 13b, and 13c shown in FIG. 4B are enlarged schematic views of pixel data in the image data 5 obtained from the CCD camera 3. Each small frame shows pixel data and, in the present embodiment, three types of contrast are illustrated using shades of darkness and numerals. This description also applies in the same manner to the flame unit pixel data 13d, 13e, 13f, 13g, 13h, 13i, 13j, 13k, and 13m.

Note that the numerical values of 0 to 255 for the pixel units are numerical values showing a general image resolution. However, the numerical value for the pixel units can be determined as is desired and it is possible, for example, for even more detailed resolution data to be provided by using numerical values from 0 to 511.

The pixel data 13d, 13e, and 13f are partially enlarged views of contrast images when a specific wavelength such as that represented by the transmission wavelength signal 12a is transmitted. Portions that appear white are where there is a large quantity of reflected light from the object being inspected 40, while portions that appear dark are where there is a small quantity of reflected light from the object being inspected 40. When a contrast image is acquired using a filter having a specific transmission wavelength region, then the white portions are substances having the strongest reflective characteristics within the wavelength region.

As is shown in FIG. 4B, in the pixel data of each of the small frames, the white portions are set to 256, the lightly dotted portions are set to 100, and the heavily dotted portions are set to 10.

When the image data of a wavelength that shows the transmission characteristics of the transmission wavelength signal 12b is enlarged and the pixel data of the same position is then displayed, the result is the pixel data 13g, 13h, and 13i in which the shading (i.e., the contrast) of pixels in the same location is different This is because image data in the same location is obtained as data in which the pixel data and contrast image in a specific wavelength region are different due to the characteristics of each of the filters.

In the exterior inspection apparatus 10, by removing image data acquired in other wavelength transmission characteristics from the image data and thereby attenuating this image data based on data having the wavelength characteristics of the substance whose extraction is desired, information on the objective wavelength is emphasized and it is easier for this information to be extracted. Namely, calculation processing is performed to subtract the pixel data 13g, 13h, and 13i, of the transmission wavelength signal 12b that had passed through the filter 2b from the pixel data 13d, 13e, and 13f of the transmission wavelength signal 12a that had passed through the filter 2a whose wavelength region is different from that of the filter 2b.

Note that because no numerical value of 0 or less is present in the pixel data, if, for example, any numerical value of 0 or less is calculated, then this is treated as if it were 0.

Accordingly, the formulas (1) to (3) below are obtained.
13d−13g=13j(255−100=155) (1)
13e−13h=13k(100−255=0) (2)
13f−13i=13m(10−10=0) (3)

As a result of the above, data of 155 and 0 are obtained and it is possible to broadly divide the image data into pixel data of the transmission wavelength signal 12a and data of areas other than this transmission wavelength signal 12a Accordingly, processing for the subsequent exterior inspection is made easier.

For example, the original 255 data is obtained by amplifying the data by a factor of 1.65, while the other data remains as 0.

Moreover, in order to perform the calculation processing of the calculation device 43 more accurately, it is essential to accurately ascertain the peak of the transmission wavelength of the object being inspected 40.

If the wavelength region that needs to be removed is known in advance, then it is possible to make the removal of the noise components even easier by, for example, storing the adjacent wavelength region data on the hard disk 6 and then subtracting this data during the calculation.

In the exterior inspection apparatus 6 of the present embodiment, by performing subtraction processing in the calculation device 43, it is possible to remove white reflection light components of metal wiring and the like that are contained in the transmission wavelength signal 12a, and also to remove the wavelength components of coated substances or the base of the object being inspected 40 and then output the result as a calculation output signal 15. It is therefore possible to extract only foreign matter information 16 and the foreign matter can be specified instantly and with a high degree of accuracy.

During the process to specify the substance of the foreign matter, if the peak where the quantity of transmission light from the contrast image is greatest is discovered, then the substance can be specified from the characteristics of this peak.

Moreover, in addition to the aforementioned method of determining the highest numerical value for the quantity of light in order to calculate the peak, because there are also cases when a plurality of peaks are present or when there is an influence from other reflection light or the like, it is also possible to employ a method in which the peak is determined by making a comparison with obtained image data that is adjacent to the transmission wavelength and then calculating an amount of change and an absolute quantity. The method used may be selected as is appropriate.

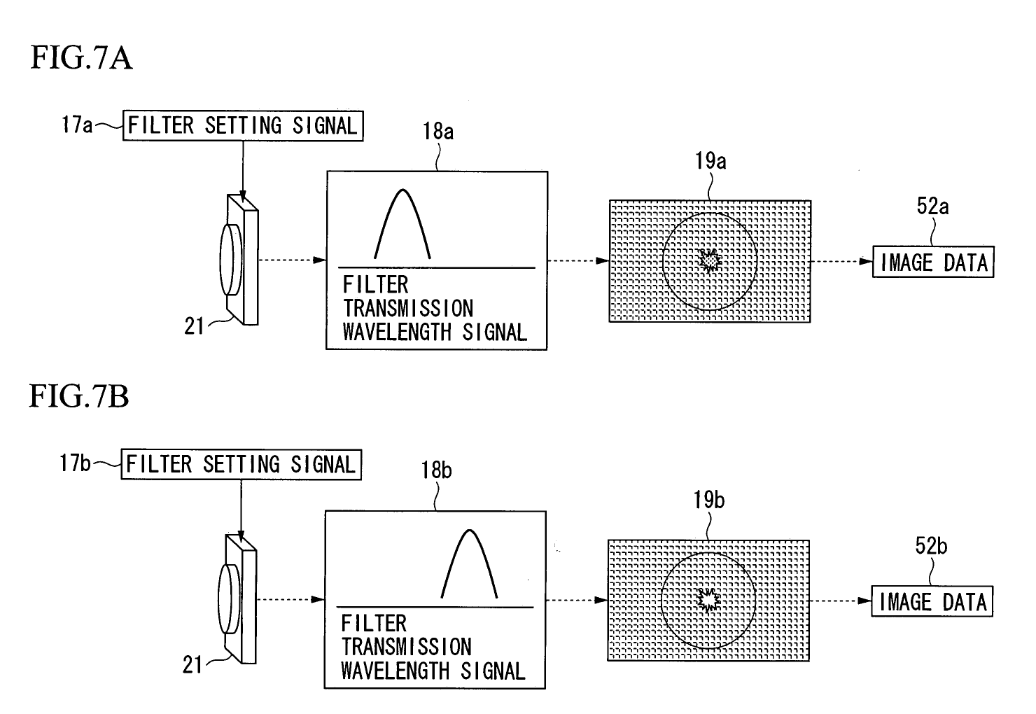

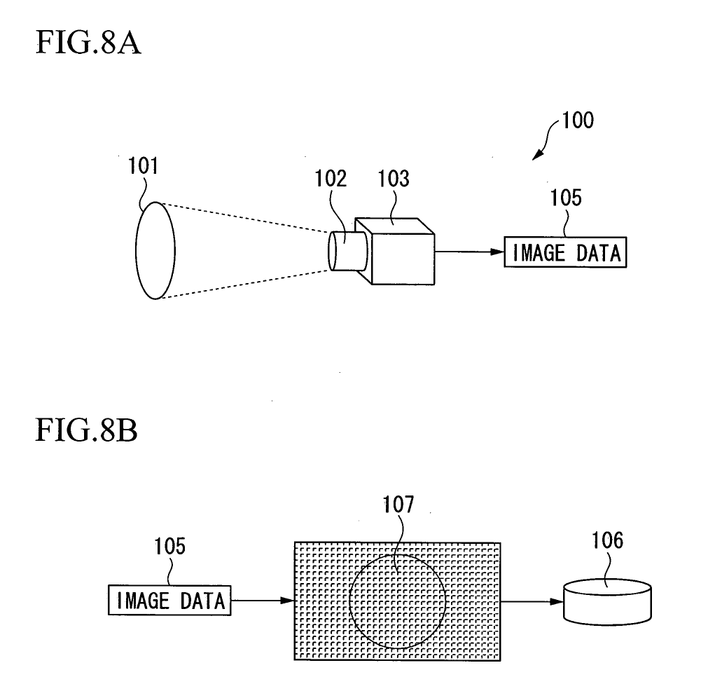

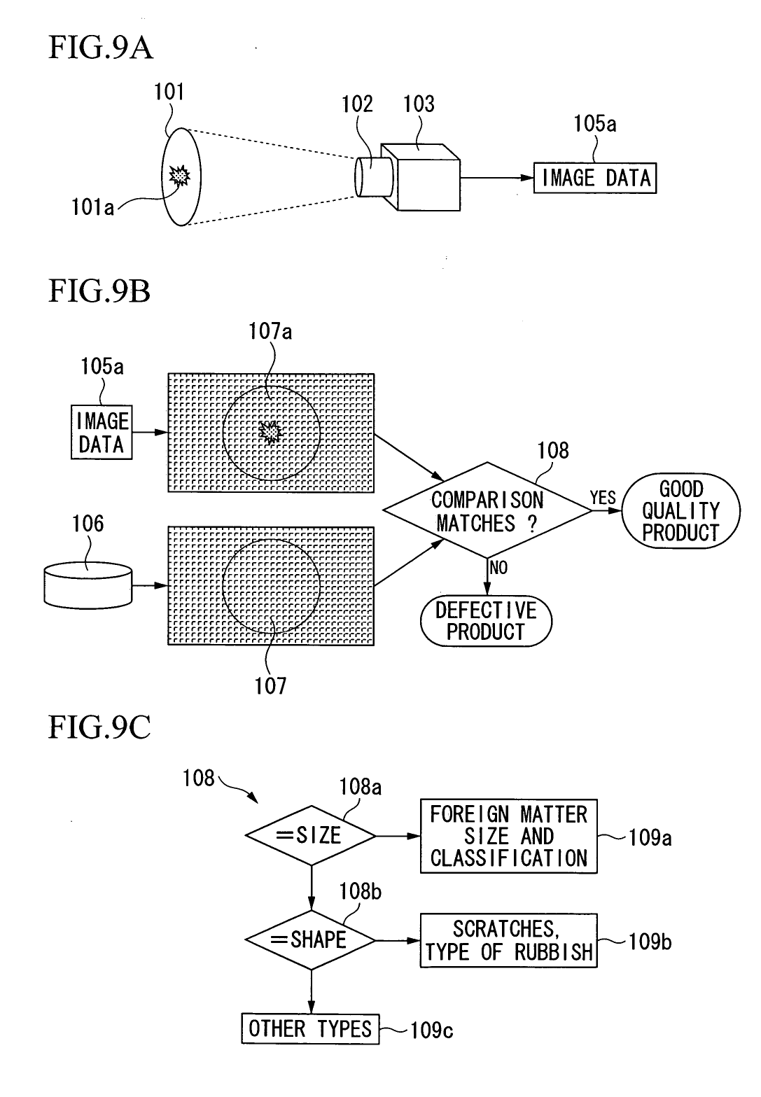

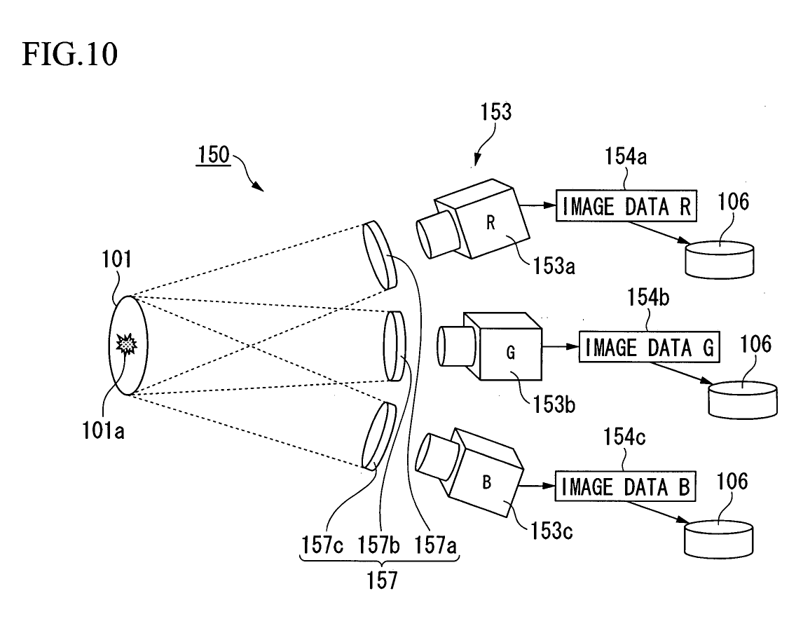

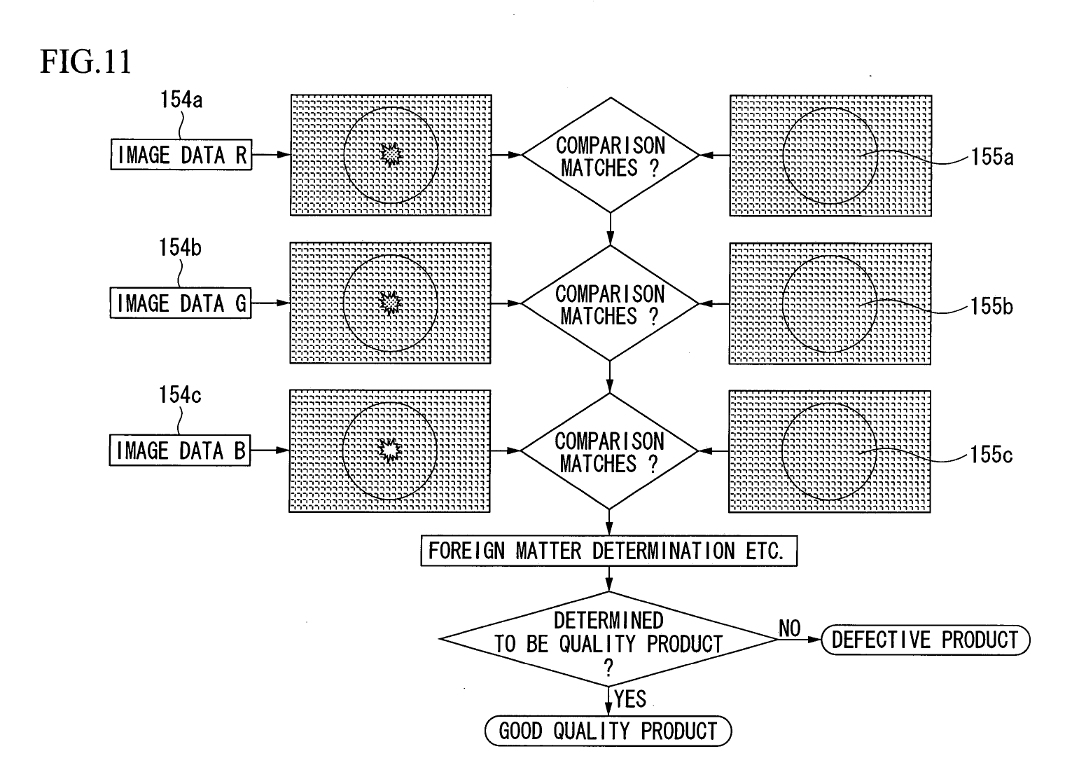

A description will now be given of the third embodiment of the exterior inspection apparatus of the present invention using FIGS. 6 and 7.

The exterior inspection apparatus 11 of the present embodiment differs from the exterior inspection apparatus of the first embodiment in that the filter used to transmit an optical image of the object being inspected 40 is formed by a variable optical filter 21 that is a planar filter having a high transmittance and is provided with a variable device for changing the transmission wavelength region.

As is shown in FIG. 6, the variable optical filter 21 changes the transmission wavelength region by altering and setting the transmission wavelength region, and picks up an image in a CCD camera 3.

The variable optical filter 21 of the present embodiment is a variable optical filter that makes it possible to transmit a specific wavelength region by stacking a plurality of liquid crystal filters. The variable optical filter 21 is structured such that transmission wavelength regions can be electrically controlled and set by a controller 22 (i.e., a variable device). The controller 22 sets a transmission wavelength region by outputting a variable wavelength transmission signal 23 to the variable optical filter 21.

The filter that is used for the variable optical filter 21 is not particularly limited provided that it has a structure that is able to electrically change the transmission wavelength of light. A filter formed from liquid crystal or an organic material, or a filter having a diffraction grating structure or the like may be employed for the filter in appropriate cases.

The exterior inspection apparatus 11 in which the variable optical filter 21 is provided behaves in the following manner.

As is shown in FIGS. 7A and 7B, in the variable optical filter 21 into which a filter setting signal 17a has been input, a transmission wavelength region is set using characteristics such as those shown by the transmission wavelength characteristics 18a In the variable optical filter 21 into which a filter setting signal 17b has been input, a transmission wavelength region is set to a wavelength region different from the transmission wavelength region 18a, as is shown by the transmission wavelength characteristics 18b.

If the reflection wavelength peak of the foreign matter 50 on the object being inspected 40 is known in advance, then the setting may be made such that the wavelength thereof forms the transmission wavelength region of the transmission wavelength characteristics 18a If the reflection wavelength peak of the foreign matter 50 is not known, then the image data is acquired while the setting of the transmission wavelength is gradually changed so as to verify the wavelength where the amount of reflection light from the foreign matter 50 is highest. Information on the central wavelength (i.e., the peak) thereof is then stored in a database in the hard disk 6. As a result, in subsequent inspections, it is possible to easily specify the substance of the foreign matter 50 by programming settings for the transmission wavelength regions using the information in this database.

When electrically altering the transmission wavelength region of the variable optical filter, the filter setting signal 17b in which the voltage or the like from the controller 22 has been changed is applied to the variable optical filter 21 so that the transmission wavelength region is changed to the transmission wavelength characteristics 18b.

After the image data 52a and 52b has been fetched using the variable optical filter 21 in which the transmission wavelength region has been set to transmission wavelength characteristics such as the transmission wavelength characteristics 18a and 18b, by then performing the calculation processing that was described in the second embodiment using the calculation device 43, a substance can be analyzed and specified.

In the exterior inspection apparatus 11 of the present embodiment, it is possible to create a program to change a transmission wavelength using the variable optical filter 21. Moreover, because the amount of change can be easily altered to intervals of 10 nm, 100 nm, or the like, a spectrum peak can be confirmed with a high degree of accuracy.

Moreover, in the exterior inspection apparatus 11, it is possible to pick up an optical image using the variable optical filter 21, superimpose the data before the transmission wavelength was changed onto the data after it was changed, extract those portions where the contrast has changed, and then obtain a wavelength peak from a comparison of the amount of change. As a result by specifying the substance of the object being inspected from the obtained image and color spectrum characteristics, and then providing a search function for other groups and the like in which this same substance is present, it is possible to simultaneously inspect a large number of unspecified substances and perform instantaneous classification and selection.

### EXAMPLES

The exterior inspection apparatus of the present invention shown in FIG. 6 was assembled and an exterior inspection of an object being inspected (i.e., a sample) was made.

(Exterior Inspection Apparatus)

A variable liquid crystal filter was employed for the filter used in the exterior inspection apparatus, and a CCD camera (an EZ-140 manufactured by Sensovation Corp.) was used for the camera. The image data was input into a personal computer and image processing was performed.

During the exterior inspection, an inspection and measurements were made as the transmission wavelength of the variable liquid crystal was changed. The exterior of the sample was divided into regions where there were changes in brightness and a spectral characteristic graph was created.

(Object being Inspected)

The articles described below were used as samples for the object being inspected and exterior inspections thereof were made.

(1) Sample A: an aluminum pattern was formed on a silicon wafer. A polyimide based resin was then coated thereon to form a semiconductor substrate (color: brown). (2) Sample B: an aluminum pattern was formed on a silicon wafer. A polymer based resin was then coated thereon and then peeled off to form a semiconductor substrate (colorless). (3) Sample C: an aluminum pattern was formed on a silicon wafer. A polymer based resin was then coated thereon to form a semiconductor substrate (color: light brown).

(Sample A)

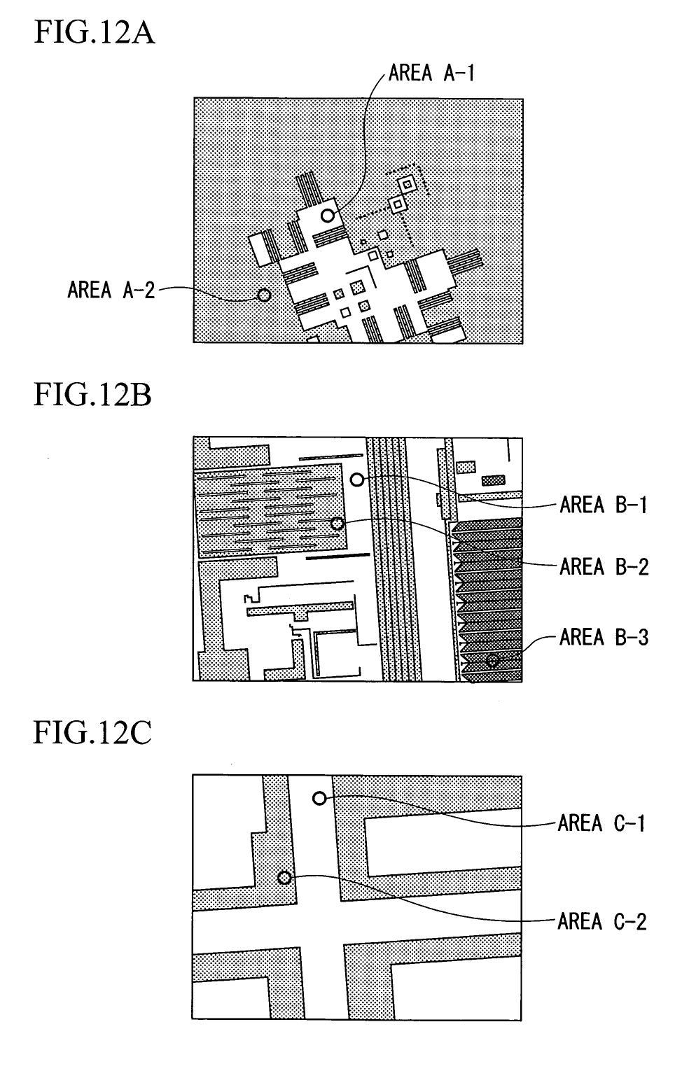

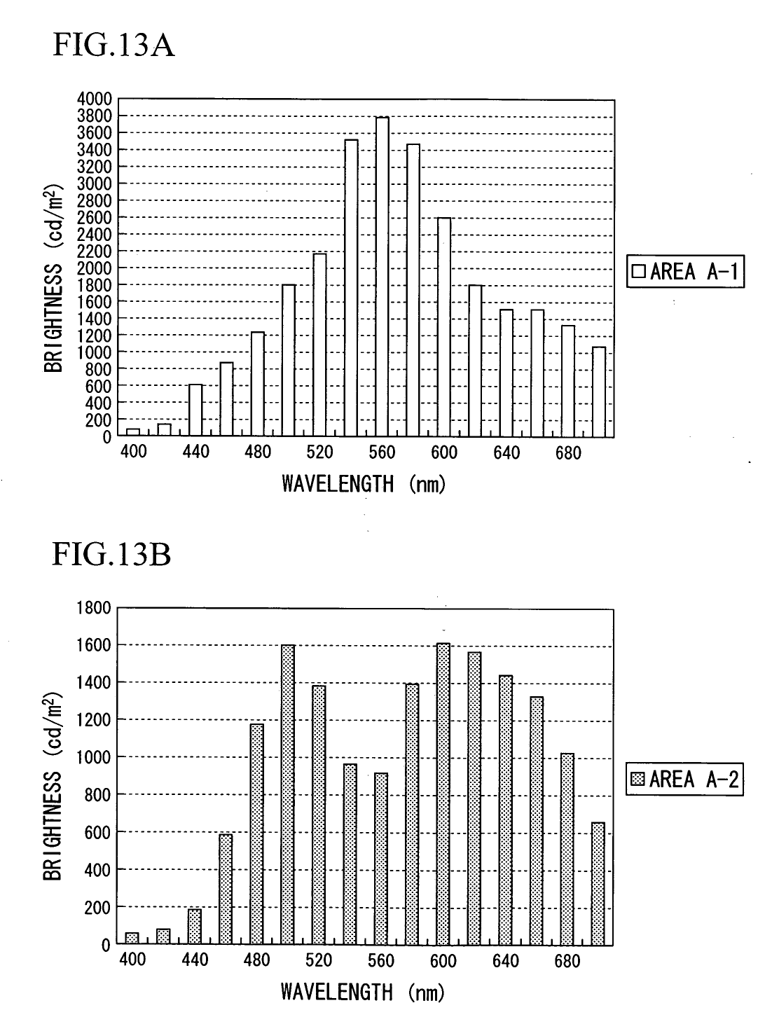

As is shown in FIG. 12A, Sample A was broadly divided into two regions that were measured. The spectral characteristic graphs shown in FIGS. 13A and 13B were created for the two regions A-1 (a wiring region) and A-2 (a semiconductor substrate region).

As is shown in FIG. 13A, in the region A-1, the brightness of the reflection light of the wiring region peaked at approximately 3800 cd/m² at a 560 nm wavelength. As the wavelength changed the graph described a mountain-shaped arc centering on this peak.

In contrast, as is shown in FIG. 13B, in the region A-2, the brightness of the reflection light of the semiconductor substrate region was approximately 900 cd/m² at a 560 nm wavelength and was lower than wavelengths peripheral thereto, for example, at 600 nm, the brightness was approximately 1600 cd/m². In addition, the graph was valley shaped as the wavelength changed with the brightness of the reflection light of the semiconductor substrate region being considerably lower than the brightness peak of the region A-1.

(Sample B)

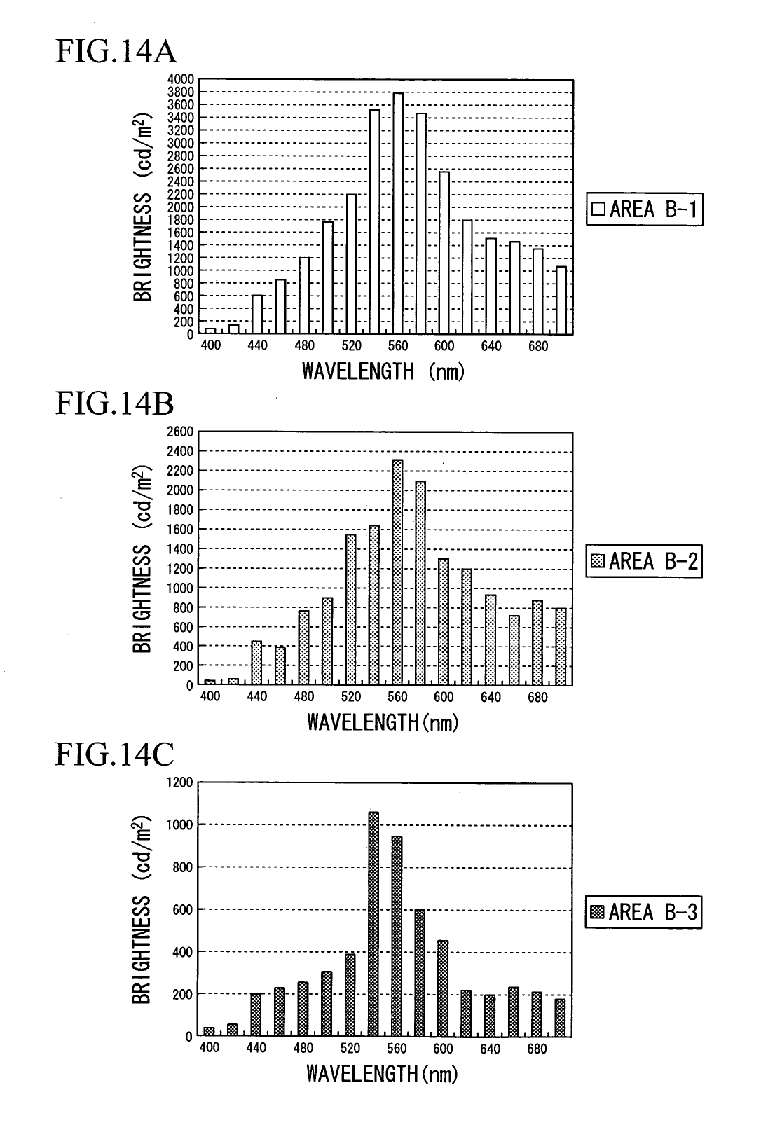

As is shown in FIG. 12B, Sample B was broadly divided into three regions that were measured. The spectral characteristic graphs shown in FIGS. 14A, 14B and 14C were created for the three regions B-1 (a wiring region), B-2 (an impurity diffusion region), and B-3 (a semiconductor substrate region).

As is shown in FIG. 14A, in the region B-1, the brightness of the reflection light of the wiring region peaked at approximately 3800 cd/m² at a 560 nm wavelength As the wavelength changed the graph described a mountain-shaped arc centering on this peak.

In contrast as is shown in FIG. 14B, in the region B-2, the brightness of the reflection light of the impurity diffusion region peaked at approximately 2300 cd/m² at a 560 nm wavelength so as to form a mountain-shaped graph. However, this brightness peak was considerably lower than the peak of the region B-2.

Moreover, as is shown in FIG. 14C, in the region B-3, the brightness of the reflection light of the semiconductor substrate region was approximately 1050 cd/m² at a 540 nm wavelength and was approximately 950 cd/m² at a 560 nm wavelength so as to form a mountain-shaped graph having a peak in this vicinity However, this brightness peak was even lower than the peaks of the regions B-2 and B-3.

(Sample C)

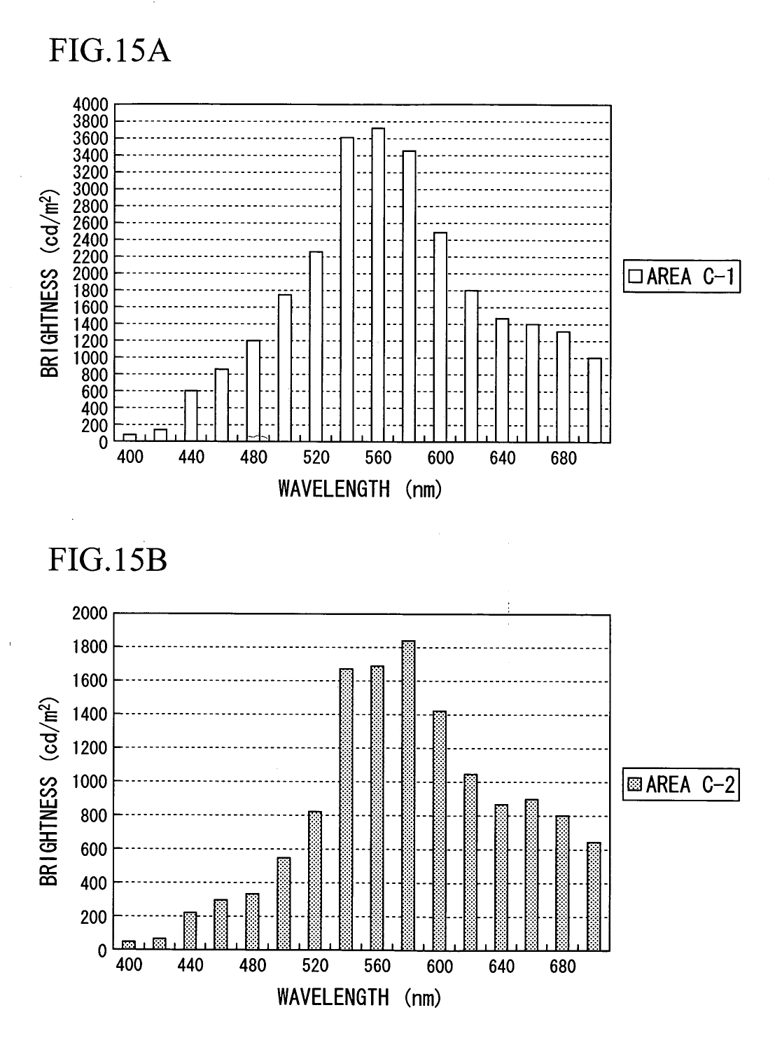

As is shown in FIG. 12C, Sample C was broadly divided into two regions that were measured. The spectral characteristic graphs shown in FIGS. 15A and 15B were created for the two regions C-1 (a wing region) and C-2 (a semiconductor substrate region).

As is shown in FIG. 15A, in the region C-1, the brightness of the reflection light of the wiring region peaked at approximately 3700 cd/m² at a 560 nm wavelength so as to form a mountain-shaped graph.

In contrast, as is shown in FIG. 15B, in the region C-2, the brightness of the reflection light of the semiconductor substrate region was approximately 1850 cd/m² at a 580 nm wavelength, and was approximately 1700 cd/m² at a 560 nm wavelength so as to form a mountain-shaped graph having a peak in this vicinity. However, this brightness peak was considerably lower than the peak of the region C-1.

When manufacturing a semiconductor substrate, the processing of the various processing modes of the above three samples is always performed in the sequence Sample C, Sample B, and Sample A.

Because the wiring region is formed in all of the samples, the reflection light is synthesized light that includes the wavelengths of the aluminum and the resin. In particular, in Sample B and Sample C that have little coloring, the spectrum principally contains a large quantity of the wavelength of the aluminum reflection light (i.e., 560 μm).

In contrast to this, because Sample A contains a large amount of brown coloring, the brightness in the vicinity of a 560 nm wavelength is lower in the region A-2 and this may be thought to be due to light absorption. Accordingly, the reflection spectrum in this case is very unique.

As a result, even if a broad exterior inspection is made over an entire sample, it is possible to instantly specify substances on the surface on the basis of color wavelength characteristics of resin or foreign matter on the sample.

From the above described results of the present embodiment, even if a plurality of substances that include foreign matter are present on the surface of an object being inspected, it is evident that by making an exterior inspection using the exterior inspection apparatus of the present invention, classifying and inspecting the substances is easy.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. An exterior inspection apparatus that picks up an image of an object being inspected and inspects an exterior of this object, comprising:
a plurality of filters that are provided in stages for differing transmission wavelengths and are positioned so as to face the object being inspected, and that only transmit a specific wavelength from an optical image of the object being inspected;
an image pickup device that picks up an optical image transmitted through the filter and outputs image data for each wavelength region;
an image processing device that creates spectrum characteristic data by analyzing differences between contrast ratios by using a comparison of the image data output for each wavelength region, and then specifies a substance based on the spectrum characteristic data; and
a database device on which the image data and the spectrum characteristic data are readably recorded as case information,
wherein the image processing device comprises:
a substance specifying section that, by reading the case information recorded on the database device and comparing this case information with the image data and spectrum characteristic data of the object being inspected, is able to specify the class of the object being inspected and then output classification information and distribution information; and
a search processing section that searches for and extracts the image data and the spectrum characteristic data that are recorded as case information on the database device.

2. The exterior inspection apparatus according to claim 1, further comprising a calculating device that calculates from the image data a wavelength spectrum distribution of reflection light reflected from the periphery of the object being inspected that forms a background noise component of the object being inspected, and then attenuates wavelength region data of this wavelength spectrum distribution.

3. The exterior inspection apparatus according to claim 1, wherein the filter is a planar filter having a high transmittance, and the filter is a variable optical filter that is provided with a variable device that changes the transmission wavelength region of the filter.

4. An exterior inspection method comprising:
providing an exterior inspection apparatus according to claim 1;
picking up an image of an object being inspected; and
inspecting the object being inspected.
